(19) United States
(12) Patent Application Publication
(10) Pub. No.: US 2025/0149622 A1
(43) Pub. Date: May 8, 2025

(54) Lean-Electrolyte Lithium-Sulfur Cell and a Method of Manufacturing the Same

(71) Applicant: NATIONAL CHENG KUNG UNIVERSITY, Tainan City (TW)

(72) Inventors: Sheng-Heng CHUNG, Tainan City (TW); Guan-Ting YU, Tainan City (TW)

(21) Appl. No.: 18/417,040

(22) Filed: Jan. 19, 2024

(30) Foreign Application Priority Data
Nov. 7, 2023 (TW) 112142894

(51) Int. Cl. H01M 10/052; H01M 4/02; H01M 4/133; H01M 4/134; H01M 4/36; H01M 10/0585

(52) U.S. Cl. CPC H01M 10/052; H01M 4/133; H01M 4/134; H01M 4/366; H01M 10/0585; H01M 2004/027; H01M 2004/028

(57) ABSTRACT

The present invention provides a lean-electrolyte lithium-sulfur cell, comprising: a cathode which contains a carbon substrate assembled with a sulfur active material to form a sulfur loading of at least 6 mg/cm²; and an anode which is produced by depositing lithium metal onto a carbon substrate; the carbon substrate of the cathode is a carbon structural material having a carbon nanotube-to-graphene weight ratio of 45:55 to 55:45; the carbon substrate of the anode is a carbon structural material having a carbon nanotube-to-graphene weight ratio of 20:80 to 30:70.

### CROSS-REFERENCE TO RELATED APPLICATIONS

This application claims the benefit of priority of Taiwan Application Number TW112142894, filed on Nov. 7, 2023, which is herein incorporated by reference in its entirety.

### TECHNICAL FILED

The present invention relates to a lean-electrolyte lithium-sulfur cell and a method of manufacturing the same, particularly a lithium-sulfur cell having electrodes with carbon structural material substrates.

### BACKGROUND

Recently, lithium-sulfur cells exhibit high theoretical charge-storage capacity and high theoretical energy density. The benefits of being low-cost and environmentally friendly of lithium-sulfur cells prepared with the goal of using sustainable energy storage active materials make them competent next-generation energy storage devices.

The sulfur electrodes of lithium-sulfur cells would undergo the solid-liquid phase transition during electrochemical reactions. Solid sulfur and lithium sulfide are highly insulating while liquid polysulfides are readily soluble in electrolyte. Therefore, the available techniques focus on the preparation of materials for sulfur electrodes. Most of studies put a lot of efforts on synthesis of composite materials by high temperature with plenty of steps or preparation of sulfur-containing composite nanomaterials with active materials absorbed in substrates due to properties thereof with toxic solvents. Otherwise, electrode substrates are prepared by adding polymer binder, high-temperature thermal decomposition, and template method. Most of these studies betray the principles of Green Chemistry. Therefore, the development of improved manufacturing methods is expected. On the other hand, the concerns regarding the lithium negative electrode of lithium-sulfur cells includes inactive lithium deposit and uneven lithium buildup. Therefore, most of the available techniques adopt template or high temperature manufacturing process to prepare lithium electrodes. No study investigates or uses a thick sheet of lithium as an electrode directly. That is, materials for positive electrodes and negative electrodes are developed independently now, instead of integrated developed.

In addition, lithium-sulfur cell technology has the following problems: (1) difficulty in achieving high loading of active materials: the highly insulating nature of sulfur active materials in the solid state, which leads to slow reactions, causes low electrochemical utilization and stability while reducing the load and content of sulfur active materials would end up insufficient charge-storage capacity and energy density; (2) excessive amount of electrolyte: the sulfur electrodes would undergo the liquid state transition during reactions and the liquid polysulfides are readily soluble in electrolyte and be lost; and the loss polysulfides that diffuse into the electrolyte corrode cell parts and increase the viscosity of the electrolyte, resulting in short cycle life and charging failures, which forces the electrolyte to be in higher quantities, leading to a lower cell energy density; and (3) excessive lithium usage due to instability of lithium negative electrode: it is needed to supplement lithium because of the inactive lithium generated in cycles of lithium-sulfur cells; however, excessive lithium usage would affect the performance of cells.

### SUMMARY

Accordingly, the present invention provides a lean-electrolyte lithium-sulfur cell and a method of manufacturing the same, which can deliver the outstanding performance including high electrochemical utilization and high cyclic stability, long cycle life and high energy density even under conditions of high sulfur loading and low amount of electrolyte.

An aspect of the present invention provides a lean-electrolyte lithium-sulfur cell, comprising: a cathode which contains a carbon substrate A assembled with a sulfur active material to form a sulfur loading of at least 6 mg/cm²; and an anode which is produced by depositing lithium metal onto a carbon substrate B; wherein the carbon substrate A of the cathode is a carbon structural material having a carbon nanotube-to-graphene weight ratio of 45:55 to 55:45; the carbon substrate B of the anode is a carbon structural material having a carbon nanotube-to-graphene weight ratio of 20:80 to 30:70.

In the lean-electrolyte lithium-sulfur cell of the present invention, preferably the cell has an electrolyte with an electrolyte-to-sulfur ratio of 4 to 6 μL/mg.

In the lean-electrolyte lithium-sulfur cell of the present invention, preferably the carbon substrate A of the cathode has a specific surface area more than 40 m²/g; the carbon substrate A of the cathode has a conductivity of more than 70 S/cm.

In the lean-electrolyte lithium-sulfur cell of the present invention, preferably the carbon substrate B of the anode has a specific surface area of less than 40 m²/g; the carbon substrate B of the anode has a of total pore volume of less than 0.06 cm³/g.

In the lean-electrolyte lithium-sulfur cell of the present invention, preferably the cell has an areal capacity of 6.1˜7.3 mA·h/cm².

In the lean-electrolyte lithium-sulfur cell of the present invention, preferably the cell has an energy density of 12.8˜14.3 mW·h/cm².

In the lean-electrolyte lithium-sulfur cell of the present invention, preferably the cell has a capacity retention rate of 55˜60% after 200 cycles at a C/10 rate.

Another aspect of the present invention provides a method of manufacturing the lean-electrolyte lithium-sulfur cell of the present invention, comprising: a step of manufacturing the carbon substrate A and the carbon substrate B, comprising mixing and dispersing carbon nanotubes and graphene by ultrasonic vibration, and then vacuum-filtering the carbon nanotubes and graphene such that the carbon nanotubes are entangled with the graphene, to form the carbon substrate A of the cathode and the carbon substrate B of the anode, respectfully; a step of manufacturing the cathode wherein the sulfur active material is stacked between two pieces of the carbon substrates A of the cathode to form the cathode; a step of manufacturing the anode wherein the lithium metal is deposited onto the carbon substrate B of the anode by plating to form the anode; a step of cell assembling wherein the cell is assembled by using the cathode, a polymeric separator and the anode and adding an electrolyte.

In the method of the present invention, preferably the cell has an electrolyte-to-sulfur ratio of 4 to 6 μL/mg.

In the method of the present invention, preferably the carbon substrate A of the cathode has a specific surface area of more than 40 m²/g; the carbon substrate A of the cathode has a conductivity of more than 70 S/cm; the carbon substrate B of the anode has a specific surface area of less than 40 m²/g; the carbon substrate B of the anode has a of total pore volume of less than 0.06 cm³/g.

The lean-electrolyte lithium-sulfur cell in accordance with the present invention exhibits high sulfur loading and outstanding performance including high electrochemical utilization and cyclic stability, long cycle life and high energy density.

The cathode made of the carbon substrate Ain the lithium-sulfur cell of the present invention can stabilize high loading of polysulfide, endow the cell with high electrochemical reactivity and stability and contribute to high sulfur loading of the high-loading sulfur electrode made therefrom (6-12 mg/cm²) and high sulfur content of 53-60 wt % (including the weight of the electrode substrate). Furthermore, the cathode made of the carbon substrate A in the lithium-sulfur cell of the present invention can integrate high-loading sulfur electrode into the lean-electrolyte cell to achieve a low electrolyte-to-sulfur ratio (4˜6 μL/mg), reduce the ratio of electrolyte to active materials, and attain the lean-electrolyte cell.

The anode made of the carbon substrate B in the lithium-sulfur cell of the present invention exhibits the stability of lithium at the anode, high Coulombic efficiency and long-term cyclic stability.

The present invention manufactures the lean-electrolyte lithium-sulfur cell with the outstanding performance by integrating the cathode made of the carbon substrate A described above and the anode made of the carbon substrate B described above.

### BRIEF DESCRIPTION OF THE DRAWINGS

FIG. 1 represents a schematic diagram of the structure of the lean-electrolyte lithium-sulfur cell in the Example.

FIG. 2A represents a cyclic voltammogram (CV) of the half-cell assembly with the cathode of the carbon structural sulfur-containing active materials C25G75 (a) in this Example.

FIG. 2B represents a cyclic voltammogram (CV) of the half-cell assembly with the cathode of the carbon structural sulfur-containing active materials C50G50 (b) in this Example.

FIG. 2C represents a cyclic voltammogram (CV) of the half-cell assembly with the cathode of the carbon structural sulfur-containing active materials C75G25 (c) in this Example.

FIG. 3 represents a cyclic performance diagram of the half-cell assembly with the cathode of the carbon structural sulfur-containing active materials C25G75 (a), C50G50 (b), C75G25 (c) at C/10 cycling rates in this Example.

FIG. 4A represents a charge/discharge voltage profile of the half-cell assembly with the cathode of the carbon structural sulfur-containing active materials C25G75 (a) at a C/10 cycling rate in this Example.

FIG. 4B represents a charge/discharge voltage profile of the half-cell assembly with the cathode of the carbon structural sulfur-containing active materials C50G50 (b) at a C/10 cycling rate in this Example.

FIG. 4C represents a charge/discharge voltage profile of the half-cell assembly with the cathode of the carbon structural sulfur-containing active materials C75G25 (c) at a C/10 cycling rate in this Example.

FIG. 5 represents a cyclic performance diagram of the cathode of the carbon structural sulfur-containing active materials C50G50 at C/10-C/2 cycling rates in this Example.

FIG. 6 represents a cyclic performance diagram of the cathode of the carbon structural sulfur-containing active materials C50G50 with a sulfur loading of 6-12 mg/cm² at a C/10 cycling rate in this Example.

FIG. 7 represents a cyclic performance diagram of the cathode of the carbon structural sulfur-containing active materials C50G50 with an electrolyte-to-sulfur ratio (E-to-S) of 6-4 μL/mg at a C/10 cycling rate in this Example.

FIG. 8 represents a voltage profile of the lithium//lithium symmetric cell with the lithium anode of the carbon structural materials (C25G75 [symbol] C50G50 [symbol] C75G25) at various areal current densities for cycles in this Example.

FIG. 9 represents lithium stripping/plating results of the lithium//lithium symmetric cell with the lithium anode of the carbon structural materials (C25G75 [symbol] C50G50 [symbol] C75G25) at 1 mA/cm² for long cycles in this Example.

FIG. 10A represents a cyclic voltammogram (CV) of the half-cell of lithium and carbon with the lithium anode of the carbon structural materials C25G75 (a) in this Example.

FIG. 10B represents a cyclic voltammogram (CV) of the half-cell of lithium and carbon with the lithium anode of the carbon structural materials C50G50 (b) in this Example.

FIG. 10C represents a cyclic voltammogram (CV) of the half-cell of lithium and carbon with the lithium anode of the carbon structural materials C75G25 (c) in this Example.

FIG. 11 represents a Coulombic efficiency cyclic diagram of the half-cell of lithium and carbon with the lithium anode of the carbon structural materials (C25G75 [symbol] C50G50 [symbol] C75G25) at current densities of 0.5-5 mA/cm² in this Example.

FIG. 12 represents an electrochemical impedance spectroscopy of the lean-electrolyte lithium-sulfur cell in this Example.

FIG. 13 represents a cyclic performance diagram of the lean-electrolyte lithium-sulfur cell at a C/10 cyclic rate in this Example.

FIG. 14 represents a charge/discharge voltage profile of the lean-electrolyte lithium-sulfur cell in this Example.

FIG. 15 represents a cyclic performance diagram of the Comparative Example 1 at a C/10 cyclic rate.

FIG. 16 represents a voltage profile of the Comparative Example 2 at various areal current densities for cycles.

### DETAILED DESCRIPTION

The embodiments of the present invention disclosed below are intended to illustrate the detailed content of the present invention and the technical effects thereof, instead of limiting the way by which the present invention is implemented.

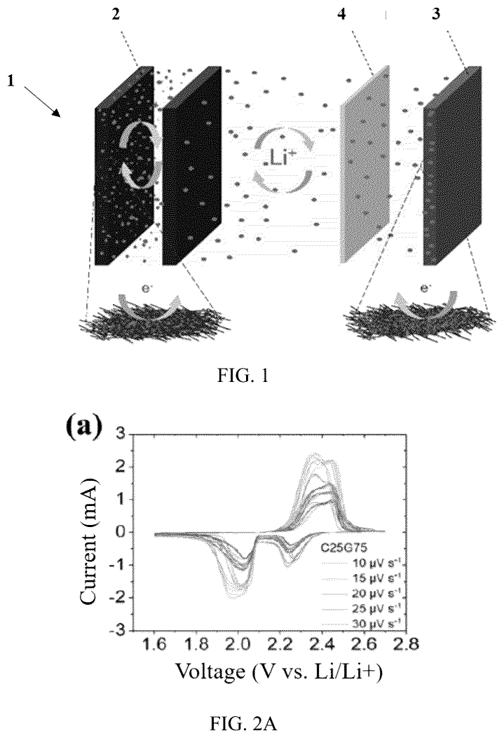

The lean-electrolyte lithium-sulfur cell of this embodiment comprises: a cathode which contains a carbon substrate A assembled with a sulfur active material to form a sulfur loading of at least 6 mg/cm²; and an anode which is produced by depositing lithium metal onto a carbon substrate B; wherein the carbon substrate A of the cathode is a carbon structural material having a carbon nanotube-to-graphene weight ratio of 45:55 to 55:45; the carbon substrate B of the anode is a carbon structural material having a carbon nanotube-to-graphene weight ratio of 20:80 to 30:70. See FIG. 1 for a schematic diagram of the structure of the lean-electrolyte lithium-sulfur cell in this embodiment, wherein the basic structure of the lithium-sulfur cell 1 is consisted of cathode 2, anode 3 and separator 4.

The carbon substrate in this embodiment is formed using carbon nanotube and graphene by Van der Waals force between carbon materials. In the carbon substrate in this embodiment, the carbon nanotube-to-graphene weight ratio (C:G) may be 20:80˜30:70, 45:55˜55:45, or 70:30˜80:20 and also may be 25:75, 50:50, or 75:25.

The manufacturing method of the lithium-sulfur cell of this embodiment comprises the following steps: a step of manufacturing the carbon substrate A and the carbon substrate B, comprising mixing and dispersing carbon nanotubes and graphene by ultrasonic vibration, and then vacuum-filtering the carbon nanotubes and graphene such that the carbon nanotubes are entangled with the graphene, to form the carbon substrate A of the cathode and the carbon substrate B of the anode, respectfully; a step of manufacturing the cathode wherein the sulfur active material is stacked between two pieces of the carbon substrates A of the cathode to form the cathode; a step of manufacturing the anode wherein the lithium metal is deposited onto the carbon substrate B of the anode by plating to form the anode; a step of cell assembling wherein the cell is assembled by using the cathode, a polymeric separator and the anode and adding an electrolyte.

The technical content of the present invention will be described specifically by the following Examples.

### Examples

### [Preparation of Carbon Substrates]

First, a total of 0.6 g of carbon nanotubes and graphene was dispersed in 400 mL of isopropyl alcohol, and the mixture was ultrasonically treated for 3 hours. The uniform dispersion was then vacuum-filtered for 1 hour to form a light carbon substrate featuring carbon nanotubes as the backbone entangled with conductive graphene. Last, the solvent was dried in an oven at 55° C. to obtain carbon substrates for the cathode and anode of cells. Furthermore, C25G75 carbon substrate, C50G50 carbon substrate, and C75G25 carbon substrate, which had carbon nanotube-to-graphene weight ratios of 25:75, 50:50, 75:25 respectively, were prepared by the method described above.

The carbon substrates in this embodiment may have a thickness of 71±2 μm and a weight per unit area of 8±0.5 mg/cm².

The graphene as a raw material had a specific surface area of 21 m²/g and a total pore volume of 0.03 cm³/g. The carbon nanotube as a raw material had a specific surface area of 91 m²/g and a total pore volume of 0.30 cm³/g. The C25G75 carbon substrate, C50G50 carbon substrate, and C75G25 carbon substrate described above had specific surface areas of 34 m²/g, 56 m²/g, 67 m²/g respectively and total pore volumes of 0.04 cm³/g, 0.08 cm³/g, 0.09 cm³/g respectively. Furthermore, the conductivity of these carbon substrates was measured via four-point measurements on a resistivity probe station (Keithley). The C25G75 carbon substrate, C50G50 carbon substrate, and C75G25 carbon substrate had conductivities of 85 S/cm, 79.6 S/cm, 63.7 S/cm respectively. Furthermore, the C25G75 carbon substrate, C50G50 carbon substrate, and C75G25 carbon substrate described above had average pore diameters of 4.73 nm, 5.52 nm, 5.59 nm respectively.

### [Cathodes of Carbon Structural Sulfur-Containing Active Materials]

First, the polysulfide catholyte with a sulfur concentration of 1.5 M was prepared by mixing sulfur powder (S) and lithium sulfide powder (Li₂S) at a 5:1 molar ratio in a regular electrolyte solvent. Here, the regular electrolyte solvent may use the electrolyte prepared as described below.

Then, the C25G75 carbon substrate, C50G50 carbon substrate, and C75G25 carbon substrate described above were cut into two pieces of 1×1 cm² carbon substrates with the same carbon nanotube-to-graphene weight ratios. The polysulfide catholyte with a sulfur concentration of 1.5 M described above was placed between the two pieces of carbon substrates to form cathodes of carbon structural sulfur-containing active materials.

### [Electrolyte]

The electrolyte for cell analysis below was prepared through dissolving 0.505 g lithium bis(trifluoromethylsulfonyl)imide (LiTFSI, 1.85 M) and 0.03325 g lithium nitrate (LiNO₃, 0.5 M) in 0.55 ml 1,2-dimethoxyethane and 0.4 ml 1,3-dioxolane by stirring at room temperature until clear liquid without precipitation was obtained.

To perform cathode evaluation, the cathodes of carbon structural sulfur-containing active materials described above (C25G75, C50G50, C75G25) were stacked with a cathode (working electrode), a polymeric separator, and a lithium-chip anode (counter and reference electrodes) to assemble half-cell assembly for cathode evaluation. The half-cell assembly had a sulfur loading of 6 mg/cm² and an electrolyte-to-sulfur ratio of 6 μL/mg. In addition, the half-cell assemblies with the same conditions, except for having sulfur loading of 9 mg/cm², 12 mg/cm², were assembled respectively by adjusting the amount of sulfur powder added in the polysulfide catholyte. In addition, the half-cell assemblies with the same conditions, except for having electrolyte-to-sulfur ratios of 5 μL/mg, 4 μL/mg, were assembled respectively by adjusting the amount of electrolyte added.

Electrochemical analysis was performed as follows. Cyclic voltammetry was performed with the potentiostat (VMP-300/BCS-805, Biologic) to verify the electrochemical reaction potential and redox reversibility of the half-cells at a voltage range of −0.1˜2.0 V and scanning rates of 100, 300, and 500 μV/s. The verification was performed with programmable battery cycler (CT-4008-5V10 mA, NEWARE) at cycling rates of C/10, C/5, and C/2 (1 C=1672 mA/g) and a voltage range of 1.6˜2.7 V (vs. Li/Li+) for 200 cycles.

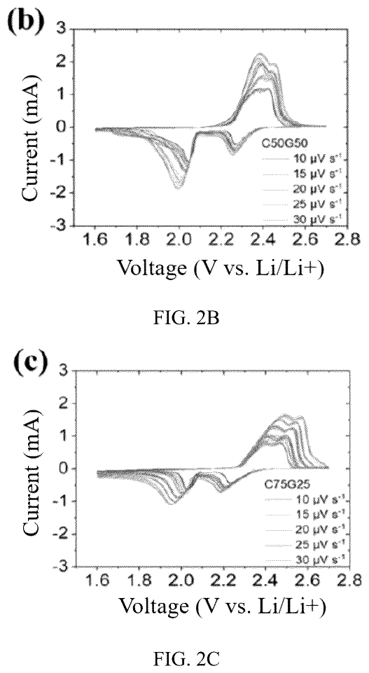

FIG. 2A, FIG. 2B, FIG. 2C represent cyclic voltammograms (CV) of the half-cell assembly with cathode of carbon structural sulfur-containing active materials C25G75 (a), C50G50 (b), C75G25 (c) in this Example. In FIG. 2A, FIG. 2B, FIG. 2C, the voltage gaps between the cathodic and anodic peaks are very small, which demonstrates a very low degree of polarization and thus prove the excellent reaction kinetics and good reversibility of the high-loading polysulfide cathodes. The half-cell assembly with cathode of carbon structural sulfur-containing active materials C50G50 showed the overlapping CV curves in repeated scans and increasing rate scans along with relatively sharp redox peaks. The results verify that, among three kinds of cathodes (C25G75, C50G50, C75G25), the cathode of carbon structural sulfur-containing active materials C50G50 has the highest reaction kinetic energy and the stable utilization of the high-capacity sulfur.

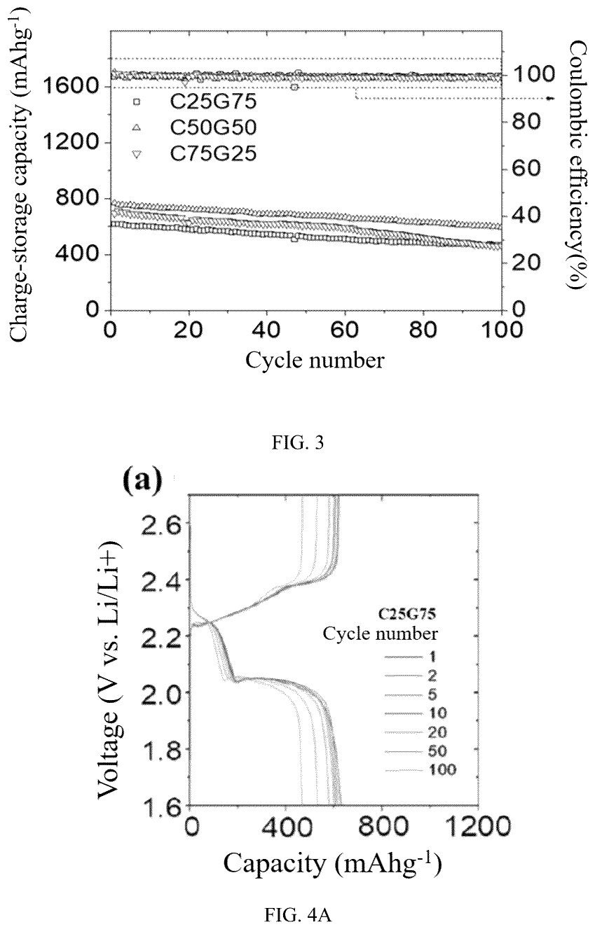

FIG. 3 represents a cyclic performance diagram of the half-cell assembly with cathode of carbon structural sulfur-containing active materials C25G75 (a), C50G50 (b), C75G25 (c) at C/10 rates in this Example. The cathodes C25G75, C50G50, and C75G25 showed high charge-storage capacities of 617, 767, and 709 mA·h/g and reversible capacities of 460, 600, and 460 mA·h/g, respectively, after 100 cycles and had high areal specific capacities of 3.7, 4.6, and 4.3 mA·h/cm² and capacity retention rates of 75%, 78%, and 65%, respectively.

For the cathode performance, cathode C25G75 provided the highest conductivity among those; however, it exhibited the lowest accessible reaction area and accumulation space, which limit the utilization of the active material. In contrast, cathode C75G25 endowed the polysulfide with a high surface area and a porous space, but the conductivity of the polysulfide was relatively low. Consequently, the cell with cathode C75G25 showed a high initial charge-storage capacity, while the utilization efficiency of the hosted active material was degraded over 60 cycles. Furthermore, cathode C50G50 endowed the polysulfide cathode with high conductivity similar to that of C25G75 and a large reaction area similar to that of C75G25; consequently, the cathode C50G50-based cell exhibited the highest electrochemical utilization and stability and a high discharge/charge efficiency.

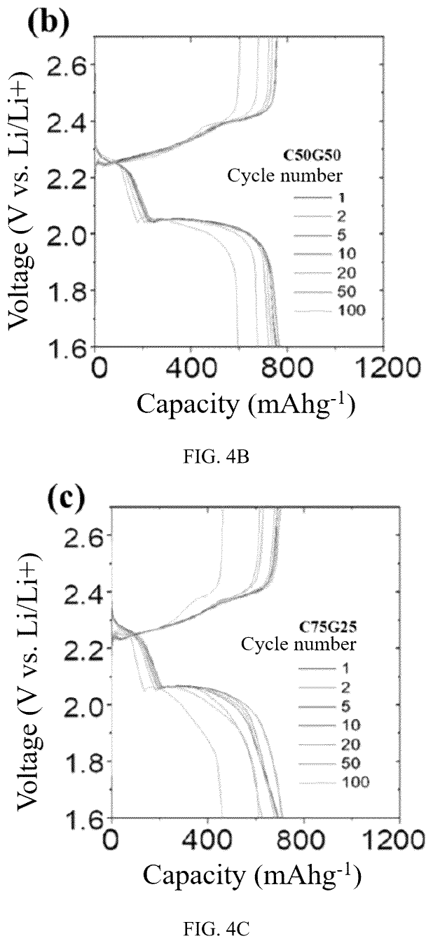

FIG. 4A, FIG. 4B, FIG. 4C represent charge/discharge voltage profiles of the half-cell assembly with cathode of carbon structural sulfur-containing active materials C25G75 (a), C50G50 (b), C75G25 (c) at C/10 rates in this Example. FIG. 4A, FIG. 4B, FIG. 4C illustrate the galvanostatic charge/discharge characteristics of the polysulfide cathodes. The carbon structure in this Example well mitigated the electrochemical unfavorable sulfur reactions including the rapid loss of the active material because of the irreversible diffusion of the dissolved polysulfides and the sluggish transition to solid-state insulating sulfides. In particular, the carbon substrate C50G50 featured a porous space for high polysulfide retention and conductive characteristics which can boost liquid-to-solid transition. The charge curves of the cathode exhibited two continuous plateaus, at 2.25 and 2.35 V. The overlapped curves for different cycles indicated the excellent cyclic stability and efficiency of the cathode of sulfur-containing active materials.

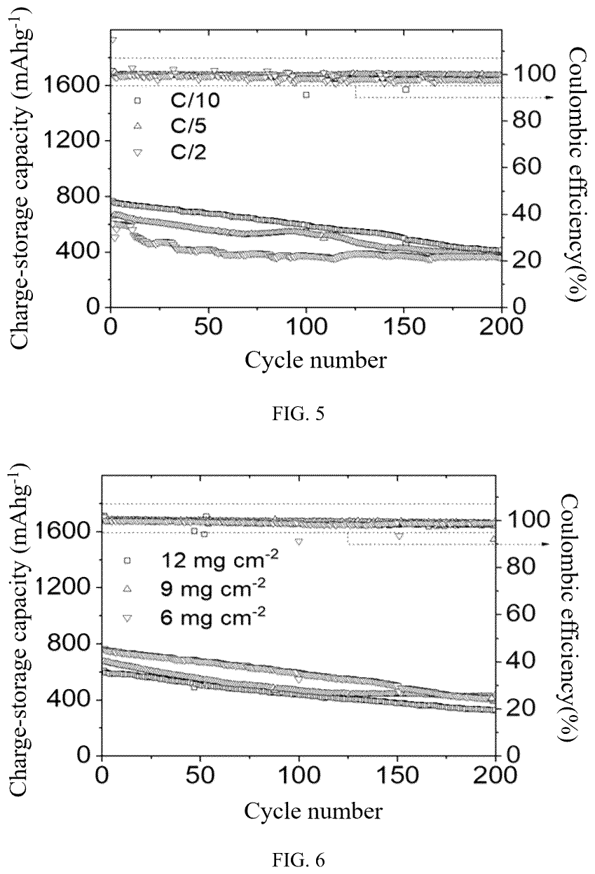

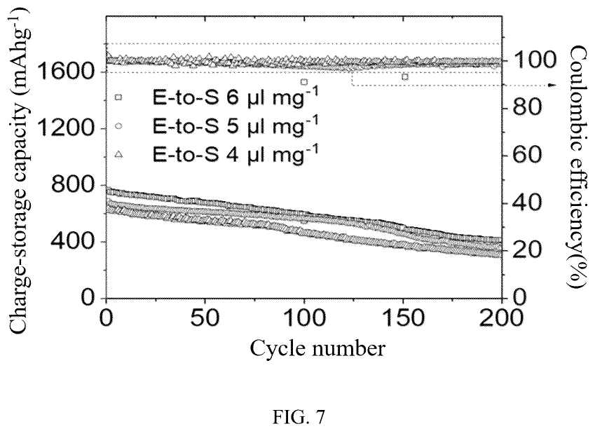

According to the electrochemical analysis above, cathode of carbon structural sulfur-containing active materials C50G50 was chosen as a preferred Example to undergo further electrochemical analysis. FIG. 5 represents a cyclic performance diagram of the cathode of carbon structural sulfur-containing active materials C50G50 at C/10-C/2 cyclic rates in this Example. FIG. 6 represents cyclability diagram of the cathode of carbon structural sulfur-containing active materials C50G50 with a sulfur loading of 6-12 mg/cm² at a cyclic C/10 rate in this Example. FIG. 7 represents a cyclic performance diagram of the cathode of carbon structural sulfur-containing active materials C50G50 with an electrolyte-to-sulfur ratio (E-to-S) of 6-4 μL/mg at a cyclic C/10 rate in this Example.

In FIG. 5, cyclic performance of the cathode C50G50 at C/10, C/5, and C/2 cyclic rates for 200 cycles was tested. The outstanding reaction kinetics and electrochemical stability of the C50G50 cathode results in excellent rate performance with long cyclic performance. FIG. 6 demonstrates the high sulfur loading of the C50G50 cathode, in particular, high sulfur loadings of 9 mg/cm² and 12 mg/cm² and a high sulfur content of 60 wt % with respect to the whole cathode. Furthermore, at a C/10 rate, the C50G50 cathode allowed for the increase in the amount of the active material used, thereby high charge-storage capacities of 675 and 610 mA·h/g were generated at sulfur loadings of 9 and 12 mg/cm², respectively, resulting in high areal capacities of 6.1 and 7.3 mA·h/cm², respectively. Also, the C50G50 cathode generated high energy densities of 12.8 and 14.3 mW·h/cm² at sulfur loadings of 9 and 12 mg/cm², respectively. FIG. 7 demonstrates that the C50G50 cathode also can achieve high reversibility of the active-material utilization and limited electrolyte consumption in the condition of the lean electrolyte, confirming the high stability of the cathode. The carbon nanotube component of the C50G50 carbon structural material allowed for effective active-material accommodation and retention, while the graphene component enhanced the chemical energy utilization efficiency and reaction kinetics. Moreover, the embedding of graphene into the entangled carbon nanotube skeleton ensured the structural and functional stability of the C50G50 cathode substrate. The cathode of carbon structural sulfur-containing active materials C50G50 in this Example exhibited very high electrochemical utilization and had a capacity retention rate of 55˜60% after 200 cycles at a C/10 rate.

### [Lithium Anode of Carbon Structural Materials]

The C25G75 carbon substrate, C50G50 carbon substrate, and C75G25 carbon substrate described above were cut into a carbon substrate with a diameter of 16 mm and plated with lithium of an areal capacity of 8 mA·h/cm² at an areal current density of 0.5 mA/cm². After plating, the anode of carbon structural materials was rinsed with 1,3-dioxolane and dried to form the lithium anode of carbon structural materials with at least 1.99 mg/cm² lithium content. As followed, to evaluate the performance of the lithium anode of carbon structural materials in this Example, the lithium//lithium symmetric cells and half-cells of lithium and carbon were analyzed.

### [Lithium//Lithium Symmetric Cells]

Evaluation for the lithium//lithium symmetric cells mainly focuses on the process of losing efficiency resulted from lithium deposition and dissolution when both of cathode and anode are lithium electrodes, wherein the process of losing efficiency includes the short circuit due to dendritic lithium growth and generation of inactive lithium.

The lithium//lithium symmetric cell was assembled using two lithium-chip electrodes. In this analysis, the lithium anode of carbon structural materials (C25G75, C50G50, C75G25) described above were used as lithium-chip electrodes.

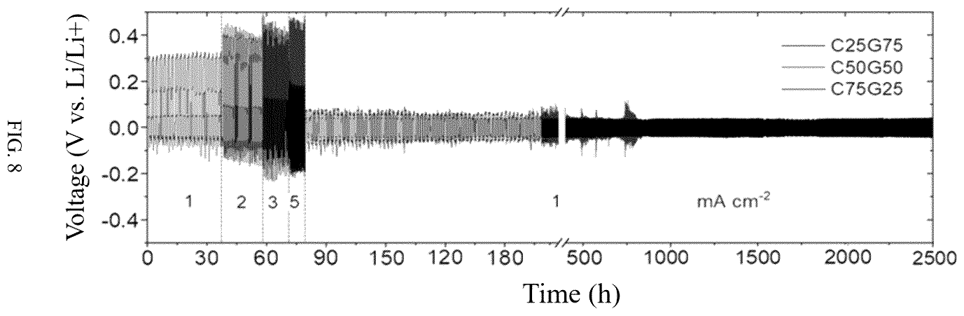

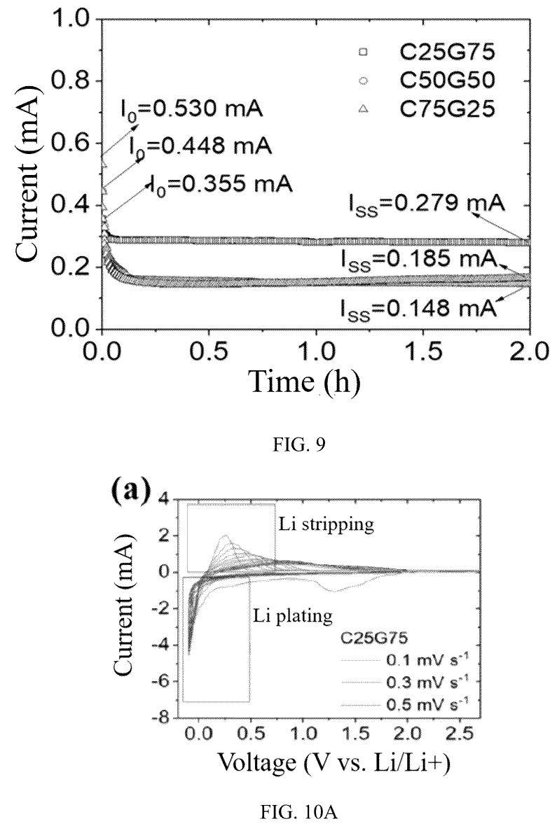

FIG. 8 represents a voltage profile of the lithium//lithium symmetric cell with lithium anode of carbon structural materials (C25G75 [symbol] C50G50 [symbol] C75G25) at various areal current densities for cycles in this Example. FIG. 8 demonstrates the stripping/plating stability and the corresponding overpotential values of the cell at high current densities of 1, 2, 3, and 5 mA/cm². Moreover, the C25G75 carbon structural material further exhibited remarkable stability of lithium deposition, dissolution and ion diffusion, with a long life span up to 2500 hours. FIG. 9 represents lithium stripping/plating results of the lithium//lithium symmetric cell with lithium anode of carbon structural materials (C25G75 [symbol] C50G50 [symbol] C75G25) at 1 mA/cm² for long cycles in this Example. The lithium ions transference numbers of the cells with lithium anode of carbon structural materials C25G75, C50G50, C75G25 were 0.68, 0.30, and 0.28, respectively, that is, the lithium anode of carbon structural materials C25G75 had a high lithium-ion transference number and therefore can suppress dendritic lithium growth.

According to the electrochemical analysis, the lithium anode of carbon structural material C25G75 was chosen as a preferred anode in this Example. The lithium anode of carbon structural material C25G75 had a higher stripping/plating stability. In contrast, the relatively high surface area and nanoporosity of the C50G50 anode and C75G25 anode may result in the consumption of a large amount of electrolyte to form the solid electrolyte interphase. Moreover, the relatively high resistance might retard the stripping/plating reaction of lithium. These factors lead to soft short circuiting in the cell with C50G50 anode and fast short circuiting in the cell with C75G25 anode in a relatively short lifetime.

### [Half-Cells of Lithium and Carbon]

Analysis for the half-cell of lithium and carbon mainly focuses on measurement and evaluation of reversibility of the lithium deposition and dissolution on substrates. The reversibility of the lithium deposition and dissolution on carbon substrates with different ratios was evaluated by measuring method for Coulombic efficiency, wherein lithium was first deposited on carbon substrates by discharging and then charged the half-cell of lithium and carbon to a specific potential.

The half-cell of lithium and carbon was assembled using carbon substrates (working electrode), a polymeric separator, and a lithium-chip anode (counter and reference electrodes). In this analysis, the lithium anode of carbon structural materials (C25G75, C50G50, C75G25) described above were used as lithium-chip electrodes.

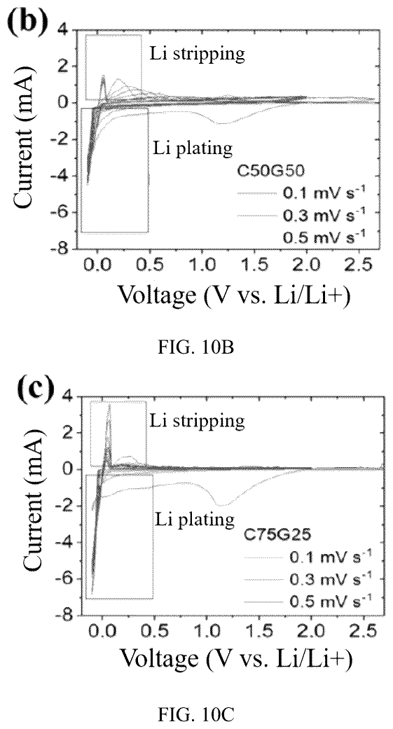

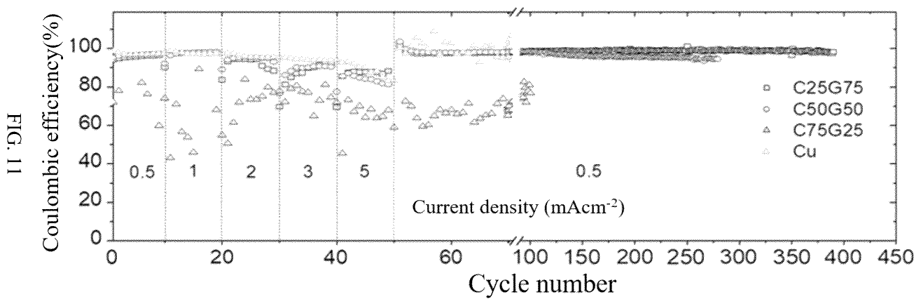

FIG. 10A, FIG. 10B, FIG. 10C represent cyclic voltammograms (CV) of the half-cell of lithium and carbon with lithium anode of carbon structural materials C25G75 (a), C50G50 (b), C75G25 (c) in this Example. In FIG. 10A, FIG. 10B, FIG. 10C, the peak at 1.25 V for Li/Li+ during the first cycle is attributable to the formation of a solid electrolyte interphase. Upon further cycling, the curves exhibited the same reduction peak at ˜0.01 V, corresponding to the lithium plating layer of the carbon electrode, and overlapping oxidation peaks at 0.25 V, corresponding to lithium stripping from the substrate. The near-overlap of the curves indicates the excellent electrochemical reversibility of the lithium deposition and dissolution reactions. With increasing scanning rates, all the lithium anodes of carbon structural materials maintained reversible reduction and oxidation peaks inherent to the system, which indicates the reversibility and stability of the electrochemical reaction of carbon structural materials during cycling. Among them, the carbon structural material C25G75 showed high stripping/plating stability as a lithium regulator, while the carbon structural materials C50G50 and C75G25 showed polarization as the amount of graphene decreased. FIG. 11 represents a Coulombic efficiency diagram of the half-cell of lithium and carbon with lithium anode of carbon structural materials (C25G75 [symbol] C50G50 [symbol] C75G25) at current densities of 0.5-5 mA/cm² for cycles in this Example. In FIG. 11, the stable lithium stripping and plating electrochemistry performance of the carbon structural materials was analyzed in terms of the Coulombic efficiency at various current densities from 0.5 to 5 mA/cm² and an areal capacity of 0.5 mA·h/cm². FIG. 11 demonstrates that the increasing current density induced high polarization, the C25G75 anode showed a high efficiency of over 96% and remained at 90% at a current density of 5 mA/cm². When the current density was returned to 0.5 mA/cm², the C25G75 anode regained a high Coulombic efficiency of 99% in the subsequent 350 cycles. The C50G50 anode maintained a high Coulombic efficiency at a low current density. However, it exhibited a lower Coulombic efficiency at a high current density and long cycle life. The C75G25 anode exhibited unstable Coulombic efficiency and a short cycle life, which is similar to that of the C50G50 anode.

The Coulombic efficiency analysis demonstrates that the C25G75 carbon structural material for lithium anode optimized the electrochemical efficiency of the lithium anode in terms of rate performance and lithium-storage capability. This is attributable to the highly conductive framework of the C25G75 carbon structural material, which enables the formation of a solid electrolyte interphase and benefits lithium deposition and dissolution. Moreover, the relatively low surface area of the carbon structural material and the nanoporosity of the carbon nanotube skeleton prevented fast electrolyte consumption while providing lithium deposition sites, thereby enabling the carbon structural material to boost the Coulombic efficiency as the lithium regulator. In contrast, the carbon structural materials of the C50G50 anode and C75G25 anode may provide abundant nanopores in the lithium-accommodating substrate and contain a small amount of graphene, which reduces the rate of lithium stripping and plating, resulting in inactive lithium precipitation and thus relatively limited the improvement in the Coulombic efficiency and cycle life.

Accordingly, the tests of lithium//lithium symmetric cells and half-cells of lithium and carbon have verified the C25G75 carbon substrate of the present invention for lithium anode exhibits excellent stability and reversibility of the lithium deposition and dissolution.

### [Lean-Electrolyte Lithium-Sulfur Cell]

The lean-electrolyte lithium-sulfur cell in this Example was assembled using the cathode of carbon structural sulfur-containing active materials C50G50 described above, a polymeric separator and the lithium anode of carbon structural materials C25G75 described above in argon atmosphere. The electrolyte described above was added into the cell to form the lean-electrolyte lithium-sulfur cell with an electrolyte-to-sulfur ratio of 6 μL/mg. Then, electrochemical analysis of the lean-electrolyte lithium-sulfur cell was performed.

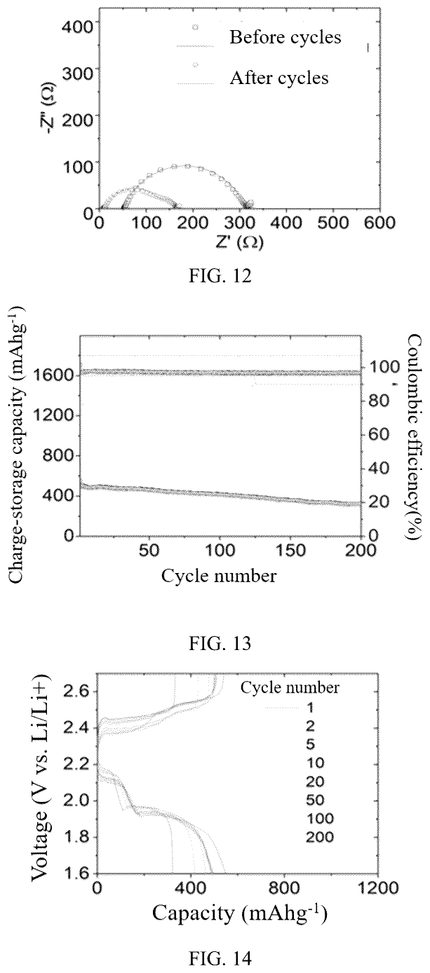

FIG. 12 represents an electrochemical impedance spectroscopy of the lean-electrolyte lithium-sulfur cell in this Example. As shown in FIG. 12, the lean-electrolyte lithium-sulfur cell in this Example maintained a low internal resistance and a low charge-transfer resistance throughout the whole cycling period and had low interfacial resistance after cycling. It may be acknowledged from the data represented by FIG. 12 that a high amount of insulating sulfur can be utilized in the presence of a low amount of electrolyte and lithium support. Moreover, lithium-ion diffusion and utilization remained stable and fast in the lean-electrolyte lithium-sulfur cell in this Example. FIG. 13 represents a cyclic performance diagram of the lean-electrolyte lithium-sulfur cell at a C/10 cyclic rate in this Example. FIG. 14 represents a charge/discharge voltage profile of the lean-electrolyte lithium-sulfur cell in this Example. As shown in FIG. 13 and FIG. 14, the lean-electrolyte lithium-sulfur cell in this Example exhibited the cyclability and the corresponding charge/discharge voltage profiles over 200 cycles and achieved a charge-storage capacity of up to 550 mA·h/g (i.e., an areal capacity of 3.3 mA·h/cm²) and a high Coulombic efficiency of 97%. After 200 cycles, the lithium-sulfur cell in this Example maintained a high reversible capacity of 323 mA·h/g and a stable Coulombic efficiency of 97% and retained 60% of its original charge-storage capacity. The corresponding charge/discharge voltage curves of the lithium-sulfur cell in this Example showed overlapping discharge curves and charge curves with no strong polarization and electrochemical loss, which indicates electrochemical reaction stability with no rapid active-material decomposition or electrolyte consumption.

In this Example, the lean-electrolyte lithium-sulfur cell assembled by using the cathode of carbon structural sulfur-containing active materials C50G50 and the lithium anode of carbon structural materials C25G75 has a sulfur loading of 6 mg/cm², an electrolyte-to-sulfur ratio of 6 μL/mg, a charge-storage capacity of 550 mA·h/g, an N/P ratio of 2.4 and a capacity retention rate of 60% at a C/10 rate after 200 cycles. The lithium-sulfur cell in this Example realizes long cycle life, high electrochemical utilization and capacity retention rate of the cell.

### Comparative Example

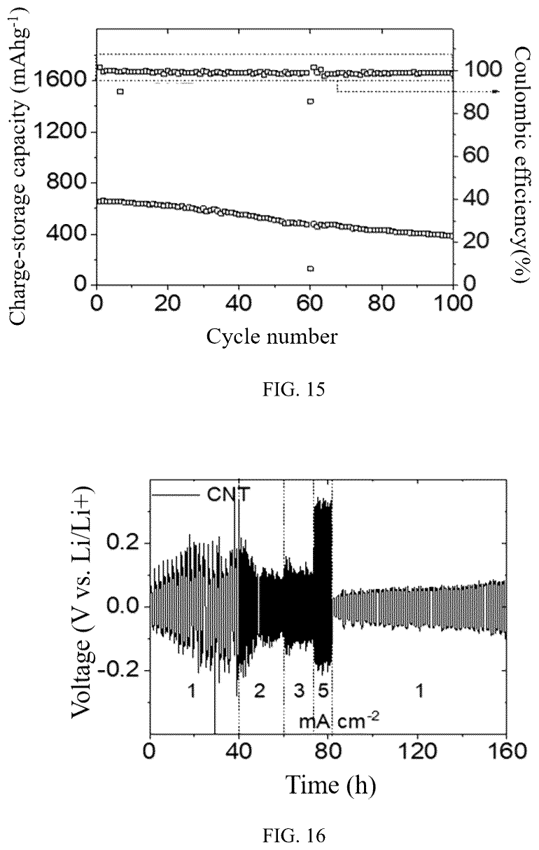

Comparative Example 1 was a cathode of carbon structural sulfur-containing active material made of carbon nanotube as the sole carbon substrate. Except for using carbon nanotube as the sole carbon substrate, the cathode of Comparative Example 1 was prepared and electrochemically analyzed by the same way as those of Examples. FIG. 15 represents a cyclic performance diagram of the Comparative Example 1 at a C/10 cyclic rate. As shown in FIG. 15, Comparative Example 1 had a charge-storage capacity of 653 mA·h/g at the first cycle while had a decreasing charge-storage capacity of 380 mA·h/g. It was apparent that the active-material utilization in Comparative Example 1 had decreased.

Comparative Example 2 was a lithium anode of carbon structural material made of carbon nanotube as the sole carbon substrate. Except for using carbon nanotube as the sole carbon substrate, the cathode of Comparative Example 2 was prepared and electrochemically analyzed by the same way as those of Examples. FIG. 16 represents a voltage profile of the Comparative Example 2 at various areal current densities for cycles. As shown in FIG. 16, Comparative Example 2 showed increased lithium-ion transfer resistance and overpotential values, which resulted in losing efficacy of lithium negative electrode.

Compared with Comparative Example 1, 2, the electrodes made of carbon substrates of specific carbon nanotube-to-graphene ratio in the present invention exhibit the outstanding technical effects including long cycle life, high electrochemical utilization and capacity retention rate, stable lithium deposition and dissolution and ion diffusion.

The Examples described above are intended to be examples of the embodiments of the present invention and illustrate the technical features of the present invention, not for limiting the scope of the present invention. Any change or equivalent arrangement which a person skilled in the art can easily come up with falls into the scope of the present invention which shall be defined by claims.

What is claimed is:

1. A lean-electrolyte lithium-sulfur cell, comprising:
a cathode which contains a carbon substrate A assembled with a sulfur active material to form a sulfur loading of at least 6 mg/cm²; and
an anode which is produced by depositing lithium metal onto a carbon substrate B;
wherein the carbon substrate A of the cathode is a carbon structural material having a carbon nanotube-to-graphene weight ratio of 45:55 to 55:45;
the carbon substrate B of the anode is a carbon structural material having a carbon nanotube-to-graphene weight ratio of 20:80 to 30:70.

2. The lean-electrolyte lithium-sulfur cell of claim 1, wherein the cell has an electrolyte with an electrolyte-to-sulfur ratio of 4 to 6 μL/mg.

3. The lean-electrolyte lithium-sulfur cell of claim 1, wherein the carbon substrate A of the cathode has a specific surface area more than 40 m²/g; the carbon substrate A of the cathode has a conductivity of more than 70 S/cm.

4. The lean-electrolyte lithium-sulfur cell of claim 1, wherein the carbon substrate B of the anode has a specific surface area of less than 40 m²/g; the carbon substrate B of the anode has a of total pore volume of less than 0.06 cm³/g.

5. The lean-electrolyte lithium-sulfur cell of claim 1, wherein the cell has an areal capacity of 6.1 to 7.3 mA·h/cm².

6. The lean-electrolyte lithium-sulfur cell of claim 1, wherein the cell has an energy density of 12.8 to 14.3 mW·h/cm².

7. The lean-electrolyte lithium-sulfur cell of claim 1, wherein the cell has a capacity retention rate of 55 to 60% after 200 cycles at a C/10 rate.

8. A method of manufacturing the lean-electrolyte lithium-sulfur cell of claim 1, comprising:
a step of manufacturing the carbon substrate A and the carbon substrate B, comprising mixing and dispersing carbon nanotubes and graphene by ultrasonic vibration, and then vacuum-filtering the carbon nanotubes and graphene such that the carbon nanotubes are entangled with the graphene, to form the carbon substrate A of the cathode and the carbon substrate B of the anode, respectfully;
a step of manufacturing the cathode wherein the sulfur active material is stacked between two pieces of the carbon substrates A of the cathode to form the cathode;
a step of manufacturing the anode wherein the lithium metal is deposited onto the carbon substrate B of the anode by plating to form the anode;
a step of cell assembling wherein the cell is assembled by using the cathode, a polymeric separator and the anode and adding an electrolyte.

9. The method of claim 8, wherein the cell has an electrolyte-to-sulfur ratio of 4 to 6 μL/mg.

10. The method of claim 8, wherein the carbon substrate A of the cathode has a specific surface area of more than 40 m²/g; the carbon substrate A of the cathode has a conductivity of more than 70 S/cm;
the carbon substrate B of the anode has a specific surface area of less than 40 m²/g; the carbon substrate B of the anode has a of total pore volume of less than 0.06 cm³/g.
